(19) United States
(12) Patent Application Publication
(10) Pub. No.: US 2026/0189614 A1
(43) Pub. Date: Jul. 2, 2026

(54) DYNAMIC AUDIO AND VIDEO DISRUPTION MITIGATION

(71) Applicant: T-Mobile USA, Inc., Bellevue, WA (US)

(72) Inventor: Cameron Brent Byrne, Seattle, WA (US)

(21) Appl. No.: 19/002,451

(22) Filed: Dec. 26, 2024

(51) Int. Cl. H04L 65/1089; G06V 10/70; G06V 10/764; G06V 10/94; G06V 20/40; H04L 65/403; H04M 3/56

(52) U.S. Cl. CPC H04L 65/1089; G06V 10/764; G06V 10/768; G06V 10/95; G06V 20/41; H04L 65/403; H04M 3/568; H04M 2201/42

(57) ABSTRACT

The present disclosure relates to systems and methods for mitigating audio and video disruptions during communication sessions. The system detects disruptions in real time using artificial intelligence (AI) models trained to identify audio and video events that fall outside the context of the call. Upon detection, the system processes the data stream to selectively omit or filter the disruptions based on user preferences. Notifications may be presented to the user, which may provide options for further mitigation actions. The system can process audio and video data streams, either independently or in combination, to enhance the overall communication experience.

### BACKGROUND

Communication technologies have advanced rapidly in recent years, enabling people to connect through audio and video calls from virtually anywhere. These technologies have become integral to both personal and professional interactions, allowing for real-time communication across long distances.

### BRIEF DESCRIPTION OF THE DRAWINGS

Detailed descriptions of implementations of the present invention will be described and explained through the use of the accompanying drawings.

FIG. 1 is an illustration of a user interface presenting options for responding to an audio disruption in accordance with one or more embodiments of the present technology.

FIG. 2 is an illustration of a user interface presented during the occurrence of an audio disruption in accordance with one or more embodiments of the present technology.

FIG. 3 is an illustration of a user interface presenting options for responding to a video disruption in accordance with one or more embodiments of the present technology.

FIG. 4A is an illustration of a user interface presented during the occurrence of a video disruption in accordance with one or more embodiments of the present technology.

FIG. 4B is an illustration of a user interface presented during the occurrence of a video disruption in accordance with one or more embodiments of the present technology.

FIG. 5 is a flow diagram that illustrates a process for mitigating audio disruptions in an audio data stream corresponding to a call.

FIG. 6 is a flow diagram that illustrates a process for mitigating video disruptions in a video data stream corresponding to a call.

FIG. 7 is a block diagram illustrating an example artificial intelligence (AI) system in accordance with one or more implementations of this disclosure.

FIG. 8 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

The convenience of mobile communication often comes with challenges related to environmental factors that can disrupt the quality and privacy of calls. One significant challenge in audio and video communication is managing unexpected disruptions that can occur during calls. These disruptions can include background noises, visual distractions, or the appearance of individuals not intended to be part of the conversation. Such interruptions can be distracting, embarrassing, or can expose sensitive information. As the use of mobile communication continues to grow, there is an increasing need for solutions that can effectively mitigate these disruptions while maintaining the seamless nature of modern communication technologies.

The technologies of the present disclosure can assist in audio and video communication by mitigating the effects of audio and/or video disruptions, such as those that occur during a phone call or a video conference. In some implementations, a software module or system can be implemented to present options to a user to determine actions taken in response to the system detecting the occurrence of a disruption. Upon detection of an audio disruption, the system can take actions that include muting the audio, filtering the disruption out of the audio data, or presenting a notification on a user interface informing a user of the disruption. Upon detection of a video disruption, the system can take actions that include blocking the video, blurring or obscuring the background of the video, blurring or obscuring a particular region of the video corresponding to the disruption, or presenting a notification to a user interface informing a user of the disruption.

In audio communications, it is common to have background noise that does not affect what the caller or the callee wants to convey. Depending on the context of the communication, particular audio events can rise to the level of an audio disruption if, for instance, they impede the intended communication of the caller, convey unwanted information, or act as a distraction. For example, if a user is speaking in a crowded place, there may be background voices in the communication. However, background noises such as alarms, car horns, or announcements over loudspeaker often rise to the level of an audio disruption. As another example, if the user is speaking in a home office for a video conference, another person entering the home office space during the video conference is considered a video disruption. The context of the communication thus represents the expected setting of the communication, such as the audio/visual surroundings of the user.

The disclosed techniques can be implemented to provide options to automatically mitigate the effects of such disruptions according to the context of the call. In some implementations, a system receives a preference of a user. For instance, the system can present a list of options on a user interface and receive a selection from the user. During a call, the system analyzes the audio data of the call to determine an audio context for the call. This audio context can include the volumes of the call, such as the volume of the user and the ambient volume of the environment, and the types of environmental noises present. The system processes the audio data in real time (e.g., with a negligible time delay between receiving audio data and receiving the results of processing the audio data) using one or more artificial intelligence (AI) or machine learning (ML) models to detect the occurrence of an audio disruption. The audio disruption can be a noise that falls outside of the audio context of the call, and the AI model can additionally be trained to detect specific disruptions, such as alarms or sirens. In response to this detection, the system responds in accordance with a preference of the user, such as blocking the transmission of audio data during the duration of the audio disruption or filtering the disruption from the audio data. The system can also present the user with a notification informing the user of the detected audio disruption and further present the user with options for mitigating the disruption.

Similarly, a user can encounter video disruptions when participating in a video call or a video conference. One example is the presence of a person other than the caller within the view of the camera. However, what is considered a video disruption depends on the context of the call. For example, the presence of another individual is not a video disruption if the caller is in a crowded area.

In some implementations, a system stores a user's preference for video mitigation. The system can present a set of options to the user and receive a selection from the user. During a call, the system analyzes the video data in real time or near real time to determine a video context for the call. This video context can include aspects such as the location of the caller (e.g., if the caller is in a home office or outdoors), the number of people present in the call, and/or the amount of background movement. For example, by performing image analysis on the background pixels during the call, the system can determine that the caller is in a moving vehicle based on the motion information conveyed in the background pixels.

The system processes the video data in real time or near real time to detect the occurrence of a video disruption. In some implementations, the system uses one or more AI models to process the video data. The one or more AI models can be trained using, for example, common disruptive events (such as a door opening or the user leaving the view of the camera) or recorded instances of actions by users taken to manually mitigate video disruptions. The system then responds to the disruption in accordance with a preference of the user, e.g., by blocking the transmission of the video data during the duration of the video disruption, obscuring or blurring the background, or presenting the user with a notification informing the user of the detected video disruption and further presenting the user with options for mitigating the disruption.

A call that includes both audio and video data can implement both example systems above and/or implement a system that combines the data for detection of audiovisual disruptions. For example, the system can use the audio data to supplement the video data in detecting video disruptions, and vice versa. Furthermore, the system can use audio and visual data to detect disruptions that result in both audio mitigation and video mitigation, each having the same or different durations. Additionally, any of these implementations can use one or more AI models to determine an audio or video context, detect an audio or video disruption, and/or process audio or video data to selectively omit an audio or video disruption.

### Audio Mitigation

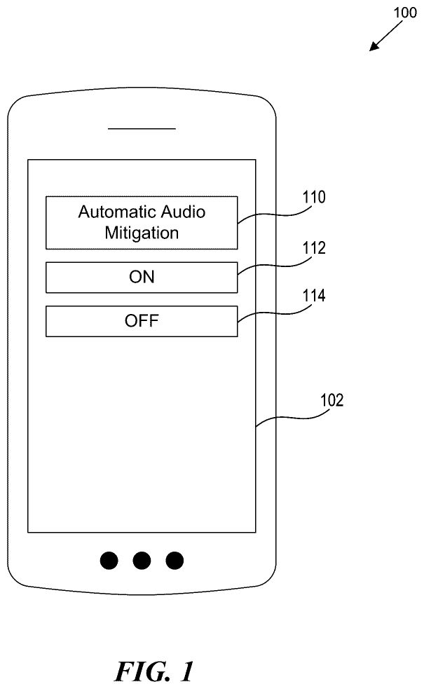

FIG. 1 is an illustration of a mobile device 100 that can implement certain aspects of the present disclosure. Mobile device 100 is a user device capable of making calls. Such calls can be audio calls that have a corresponding audio data stream that is transmitted from the mobile device 100 to one or more destination devices. Mobile device 100 can also be capable of making calls that have corresponding video data. Mobile device 100 can include a display screen 102, such as a touch screen for receiving user input. The display screen 102 of the mobile device 100 can present an audio mitigation option 110. In some implementations, the audio mitigation option 110 is presented with selectable graphics 112, 114, which, when selected by the user, set an audio mitigation preference setting. The selectable graphics 112, 114 can be selected through a user touch, if the display screen 102 is a touchscreen, or otherwise through any interface of the mobile device 100. Although the audio mitigation option 110 is shown as a graphical button, the present technology is not limited by the choice of presentation of the audio mitigation option 110 to a user. Other implementations include graphical interfaces such as radio buttons, checkboxes, toggle switches, or sliders. Other implementations include a physical button or input on the mobile device 100; text input, such as a written command to a digital assistant; touch gestures; visual gestures, such as through facial recognition or hand gestures; motion gestures, such as shaking or tilting the mobile device 100; and/or voice recognition, such as through spoken commands.

In some implementations, the audio mitigation options 110 displayed on the screen 102 can include options to perform audio mitigation actions on the audio disruption, such as muting the audio of the call during the duration of the audio disruption or processing the audio data of the call to remove the audio disruption while preserving other aspects of the communication. These actions can be taken simultaneously with a notification action, such as presenting a notification that an audio disruption has been detected, a notification of what audio mitigation action is being performed or that no audio mitigation action is being performed, and/or a presentation of audio mitigation options that can be selected by the user. Selecting an audio mitigation option sets a preference setting reflecting the chosen option, e.g., a choice of an audio mitigation action and/or a notification action to be performed.

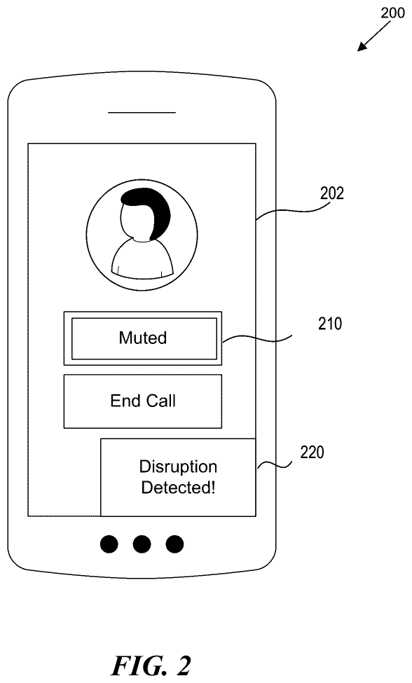

FIG. 2 is an illustration of a mobile device 200 that can implement certain aspects of the present disclosure. Mobile device 200 can include display screen 202, such as a touch screen for receiving user input. In some implementations, while a call is ongoing, a system determines an audio context of the call by analyzing data such as the audio data of the call, the location of the mobile device 200, the time and/or date of the call, or details of the caller and/or callee. The audio context of the call is used to determine, in part, whether a certain audio noise (also called an audio event) is an audio disruption. For example, if an audio event falls outside of the audio context of the call, the audio event is considered to be an audio disruption. As another example, the audio data is analyzed to determine the average expected volume for each voice present in the call. If a voice is detected with a much higher volume, the voice is identified as an audio disruption. In some implementations, the audio context is determined by processing the audio data of the call in real time or near real time using one or more AI/ML models.

In some implementations, the audio context is determined in part by the presence of ambient audio noises (also called ambient audio events), such as music, voices, or sirens. Ambient audio noises are audio noises of a certain type that occur frequently or continually in an audio data stream. For example, if a caller is at the scene of an emergency, there can be sirens constantly present in the audio data. In such cases, it would not be helpful to mute the audio data when a siren is detected. The audio context can be determined by these ambient audio noises (e.g., sirens) so that they are not considered audio disruptions. As another example, if music is continually present in audio data, the music can be considered an ambient audio noise and not be considered an audio disruption. In some implementations, the audio context is determined in part by a speaking voice of a user. For example, a system can analyze the speaking voice of a caller to determine if another voice is present in the audio data of a call and determine that the other voice is an audio disruption.

When an audio disruption is detected, one or more actions are taken in accordance with an audio mitigation preference setting. For instance, the audio disruption can be selectively omitted from the audio data by muting the call during the duration of the audio. The muting action can be represented on the display screen 202 by a muting indicator 210. Another example of selectively omitting the audio disruption is to remove the audio disruption from the audio data while preserving other aspects of the audio data. In addition, a notification 220 can be displayed on the display screen 202 when an audio disruption is detected, in accordance with an audio mitigation preference setting. This notification 220 indicates the audio mitigation action being taken (or that no action has been taken). The notification 220 can further present options using selectable graphics, which, when selected by the user, set an audio mitigation preference setting, such as an audio mitigation action to be taken.

In some implementations, the audio disruption is detected by processing audio data in real time or near real time using one or more AI or ML models. Such a model can be trained using data relevant to audio mitigation, such as examples of sirens, alarms, or other known audio disruptions. Such models can be trained using real-world data pertaining to manual audio mitigation, such as examples of audio data where a user is known to have manually muted the call in response to an audio disruption.

### Video Mitigation

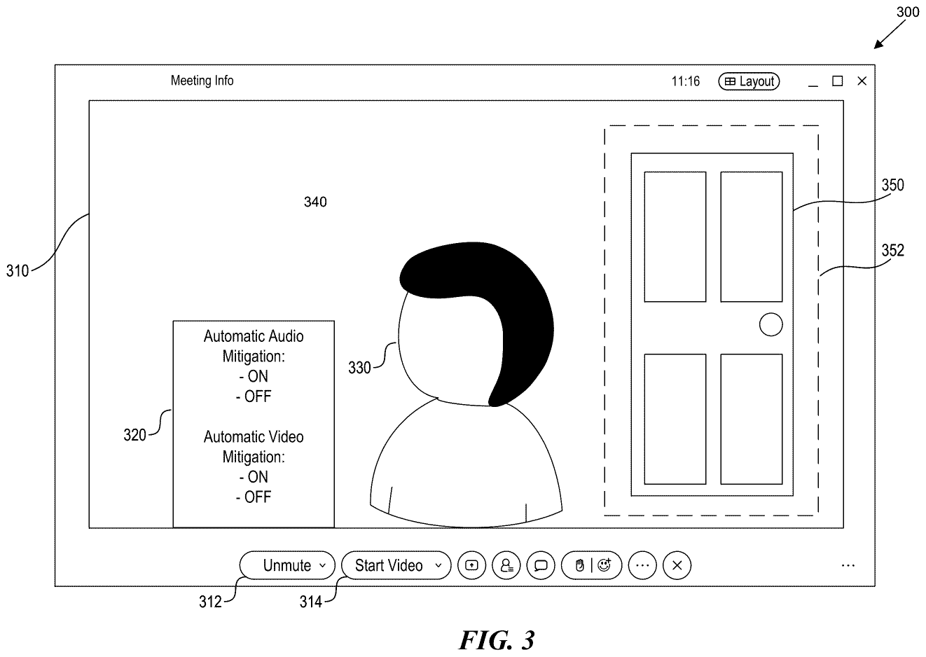

FIG. 3 is an illustration of a user interface 300 in which certain aspects of the present disclosure can be implemented. Such a user interface can be implemented on any computing device, such as a laptop computer, or mobile device, such as mobile device 100 of FIG. 1 or mobile device 200 of FIG. 2. The user interface 300 includes a video depiction 310 of video data associated with a call. A call can be a video call, which includes video data, or a video conference, which includes video data and audio data. The call is between at least a first device, which sends associated video data, and a second device, that receives associated video data. The call may include other devices that also send and receive video data. Any such device can be any computing device, such as a personal computer, mobile device, or cloud-based network server. This video data can be taken from a video camera, e.g., showing a scene including one or more users 330, an environment 340, and one or more environmental objects 350. The user interface 300 includes a mute option 312 to selectively transmit audio data and a video option 314 to selectively transmit video data. The user interface 300 can further provide options in the form of selectable graphics 320, which, when selected by a user, set an audiovisual mitigation preference setting, which can include an audio mitigation preference setting and/or a video mitigation preference setting.

In some implementations, while a video call or a video conference is ongoing, the system determines a video context of the call. The system analyzes audiovisual data corresponding to the call, which can include audio data and/or video data corresponding to the call. At least in part based on the video context of the call, the system decides whether a certain video event is a video disruption. For example, if a video event falls outside of a video context of the call (e.g., a person appearing in a home office during a work conference call), the video event is considered a video disruption. In some implementations, an audio context and a video context are determined independently. In some implementations, a video context for the call includes the environment 340 depicted in the video data, e.g., whether the setting is a home office, a conference room, or an outdoor public space.

In some implementations, a video context of the call includes certain objects identified in the video data, such as one or more users 330 or one or more environmental objects 350. The number of the one or more users 330 can be used to detect, for instance, a video disruption showing another individual entering the scene of the video call. Certain environmental objects 350 in the video scene can present a greater risk of being a video disruption. For example, the door of a home office can be a video disruption when an individual opens the door and enters the scene of the call. In such cases, a particular region 352 is identified as a candidate region for a video disruption based on the determination that the particular region 352 includes one or more high-risk environmental objects 350. This identifies the particular region 352 as a high-risk region of the video data. These or other aspects of the video context of the call can be used together to help determine the occurrence of a video disruption.

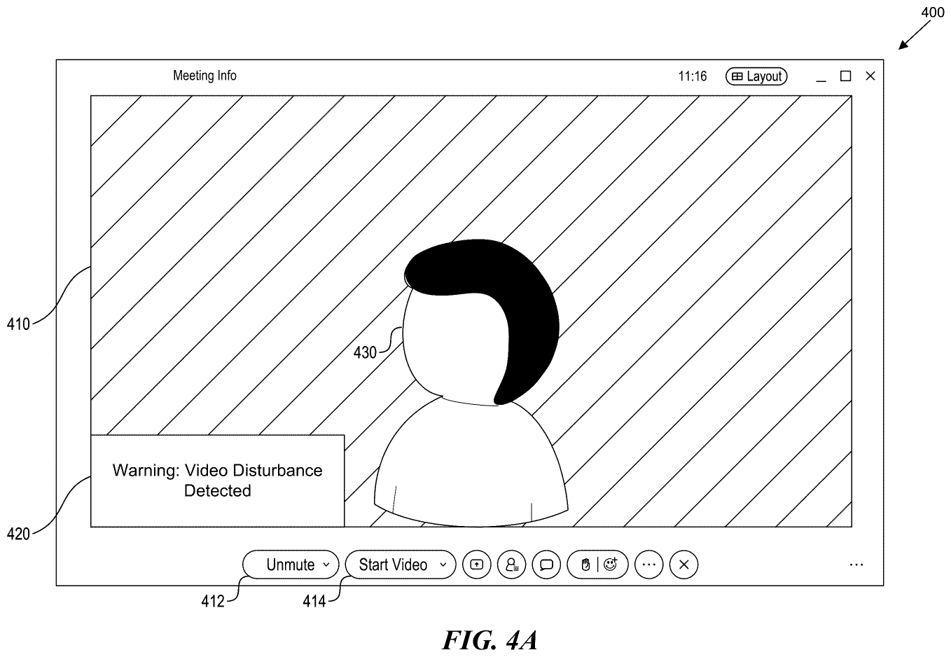

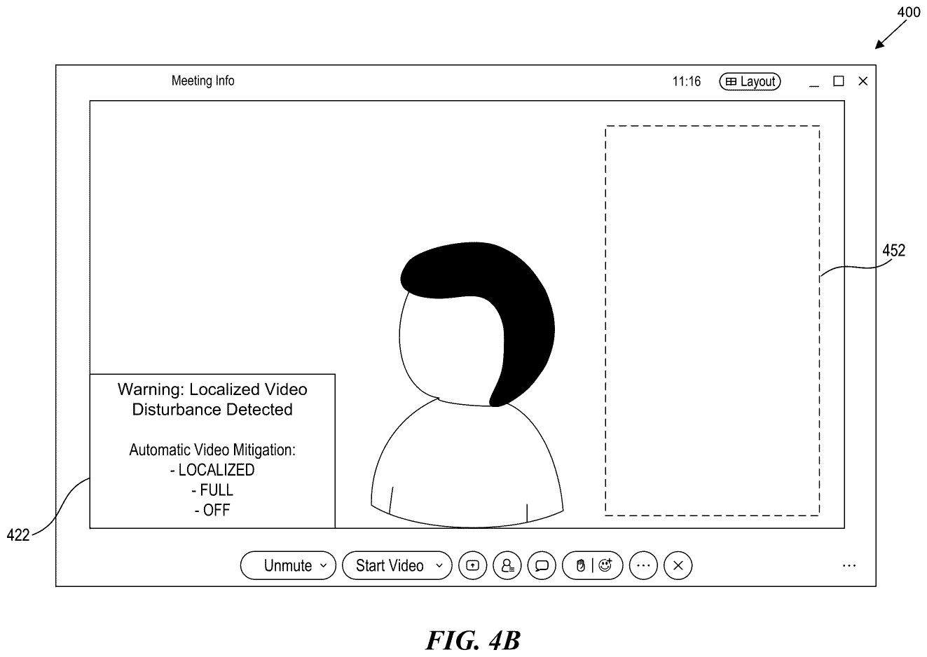

FIG. 4A is an illustration of a user interface 400 in which certain aspects of the present disclosure can be implemented. In some implementations, when a video disruption is detected, a video mitigation action is taken in accordance with a video mitigation preference setting. This preference setting includes an option of a video mitigation action to take in response to the detection, such as selectively omitting at least part of the video to remove the disruption. For example, the transmission of video data is blocked in its entirety, which is indicated through the graphic accompanying the video option 414. As another example, part of the video data is blocked or removed. As shown in FIG. 4A, background video data surrounding one or more users 430 is removed, blurred, or otherwise obfuscated. If the video disruption occurs in a region of the video data that was determined to be a high-risk region, the video mitigation action can be to only omit the video data within the high-risk region. FIG. 4B shows another example in which a particular region 452 is removed, blurred, or otherwise obfuscated. The particular region 452 can correspond to the particular region 352 including one or more high-risk environmental objects 350, and the removal of the particular region 452 from the video data stream can correspond to the detection of a video disruption corresponding to the one or more high-risk environmental objects 350. In addition, a video mitigation preference setting can include an option of a notification action, such as presenting a notification 420 on the user interface 400. The notification 420 indicates that a video disruption has been detected, the video mitigation action taken in response, and/or options 422 to change a video mitigation preference setting.

In some implementations, both audio data and video data are used to detect an audio disruption and/or a video disruption. For instance, if a certain type of video disruption often has an accompanying audio event, then the audio and video data can be used together to determine the occurrence of the video disruption based on the video context. Similarly, a video event can be used in part to determine if an audio event is an audio disruption based on the audio context. The audio and video disruptions are not required to have the same starting or ending times and can be selectively omitted independently while using both audio and video data to assist in their detections. The audio and video mitigation actions and the notification actions to be taken in response to the detections are in accordance with audio and video mitigation preference settings.

In some implementations, an audiovisual data stream, which can include an audio data stream and/or a video data stream, is used to detect an audiovisual disruption, which can include an audio disruption and/or a video disruption. The audiovisual data is used to determine an audiovisual context, which represents an expected audio surrounding of a user and an expected visual surrounding of the user. A system can use the audiovisual context to determine if an audiovisual event, which includes an audio event and/or a video event, is an audiovisual disruption. The system can then selectively omit the audiovisual disruption from the audiovisual data stream.

In some implementations, the audio and/or video data are processed in real time by artificial intelligence (AI) models or machine learning (ML) models. In some implementations, an audio disruption is detected by processing audio data in real time using one or more AI models. Such a model is trained using audio disruption data, such as examples of sirens, alarms, or other known audio disruptions. In some implementations, time-marked data, such as audio data with labels referring to the times at which an audio disruption is occurring, or real-world data pertaining to manual audio mitigation, such as examples of audio data where a user is known to have manually muted the call in response to an audio disruption, can be used to train the AI model(s). Similarly, in some implementations, a video disruption is detected by processing video data in real time or near real time using one or more AI model(s). Such a model is trained using video disruption data, such as examples of individuals or pets entering a scene. In some implementations, time-marked data, such as video data with labels referring to the times at which a video disruption is occurring, or real-world data pertaining to manual video mitigation, such as examples of video data where a user is known to have manually paused the video of the call in response to a video disruption, can be used to train the AI model(s). Such AI models can be used in combination to detect audiovisual disruptions in audiovisual data. In addition, the one or more models can be trained on combined audio and video data in order to determine an audio or video context, an audio or video disruption, or any combination thereof, such as an audiovisual context or an audiovisual disruption.

Processing of audio or video data, such as to determine a context or detect disruptions, can be executed on the same or different systems as the audio or video mitigation. For example, a user sets an audio or video mitigation preference setting on a local device, wherein the audio or video data stream is processed by a cloud-based network server as part of the transmission of the data stream from source to destination. Furthermore, the selective omitting of audio or video data can also be performed by a cloud-based service involved with the sending, transmitting, or receiving of the data stream associated with a call or a video conference. In some implementations, the system implementing aspects of the current technology may comprise multiple systems, each performing part of the disclosed technology. Thus, the system can be partially implemented on a mobile device, personal computer, network server, or any combination thereof.

In some implementations, an audio and/or video mitigation preference setting is stored on a user device, such as the Mobile device 100, a separate device, such as a cloud-based network server, or a combination thereof. In some implementations, an audio and/or video mitigation preference setting is set by a process other than user selection, such as a Mobile device 100 that has a built-in preferred audio and/or video mitigation preference setting, a Mobile device 100 with software to automatically choose a mitigation preference setting, or a cloud-based network service with a default mitigation preference setting. In some implementations, a system performs an audio and/or video mitigation action without input from a user.

### Audio Mitigation Flowchart

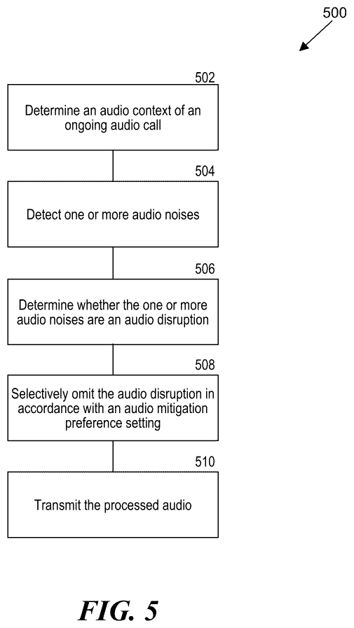

FIG. 5 is a flow diagram 500 that illustrates a process for mitigating audio disruptions in an audio data stream corresponding with an audio call. Such calls can also include video data. These steps can be performed on any computer system, including a personal computer or a mobile device. An audio call is between at least a first device, which sends associated audio data, and a second device, that receives associated audio data. The audio call may include other devices that also send and receive audio data. Any such device can be any computing device, such as a personal computer, mobile device, or cloud-based network server.

At 502, the system determines an audio context for an ongoing audio call. This can be determined by processing an audio data stream associated with the call. The audio context of a call can include various aspects of the audio environment and communication characteristics. In some implementations, the audio context can encompass the ambient noises of the caller's surroundings, such as ambient audio volume or ambient audio events, which can help distinguish between expected background sounds and potential disruptions. For example, the sound of a siren can be considered an audio disruption under some audio contexts, but not when the caller is at the site of an emergency response. The audio context can also include the speaking voice of a user, such as a user's speaking volume or pattern of conversation, and the number of users participating in the call. In some cases, the audio context can take into account the type of call, such as a professional meeting or a casual conversation, which can influence what is considered a disruption. In some implementations, the system determines an audio context by receiving an indication of the audio context from another device. In some implementations, the audio context of the call can be determined in part by analyzing the audio data using an AI model.

At 504, the system detects one or more audio noises in the audio data stream associated with the ongoing audio call.

At 506, while the call is ongoing, the system determines whether the one or more detected audio noises are an audio disruption based on the audio context. An audio disruption is an audio noise (also called an audio event) that falls outside an audio context of a call. In some implementations, the detection at 506 can be performed in real time or near real time while a call is ongoing. The system can analyze the audio data stream using various techniques, such as analyzing the audio data stream using an artificial intelligence (AI) model trained to identify audio events that fall outside an audio context of the call. Such models can be trained on audio data along with training labels that indicate the times during which an audio disruption occurs. For example, audio data wherein a user muted their audio during an audio disruption can be labeled with the times during which the user manually muted the audio.

At 508, the audio data stream is processed to selectively omit the audio disruption in accordance with an audio mitigation preference setting. This processing can be in response to the occurrence detected at 506. The system first determines an audio mitigation preference setting indicating whether an audio disruption in the ongoing call is to be removed or otherwise selectively omitted. This can involve accessing a stored user preference or presenting options to a user through a user interface to establish how audio disruptions should be handled. This preference setting can be set by a user prior to the occurrence of the call. In some implementations, the detection of an audio disruption during a call causes a notification to be displayed to a user that includes audio mitigation options. The system can display the notification in accordance with preference settings that have already been set. The user can then change the audio mitigation preference setting in response to the detection of the audio disruption, such as indicating that the audio disruption is to be removed from the audio data stream.

In some implementations, the selective omission can involve muting the audio data stream for the duration of the disruption. In some implementations, the system can apply audio filtering techniques to remove or reduce the impact of the disruptive audio event while preserving other audio content. This audio mitigation action can be performed along with a notification action in accordance with an audio mitigation preference setting. A notification action can include notifying the user of the audio mitigation action, such as presenting to a user a notification that the audio disruption has been omitted from the audio data stream or notifying the user that an audio disruption has been detected but that no audio mitigation action has been taken, for instance, when an audio mitigation preference setting is such that no audio mitigation action is to be taken. The notification can further include the presentation of options for changing an audio mitigation preference setting.

In some implementations, the call associated with the audio data stream is also associated with a video data stream, together making an audiovisual data stream. The video data stream can be processed independently to detect and mitigate video disruptions or can be processed in conjunction with the audio data stream for determining audio disruptions. In some implementations, a video data stream associated with the audio data stream is processed, and an occurrence of a video event associated with an audio event is determined. These events may together be indicative of an audio disruption (i.e., the audio event is determined to be an audio disruption), a video disruption (i.e., the video event is determined to be a video disruption), or an audiovisual disruption (i.e., a disruption in both the audio data and the video data). Thus, some implementations can detect an occurrence of an audio disruption in an audio data stream while the call is ongoing, based at least in part on the occurrence of the video event. Furthermore, the video event may also be selectively omitted from the video data stream by processing the video data stream.

At 510, the processed audio stream is transmitted. The transmission can occur in real time or near real time, allowing for seamless continuation of the call with reduced impact from the detected disruption.

### Video Mitigation Flowchart

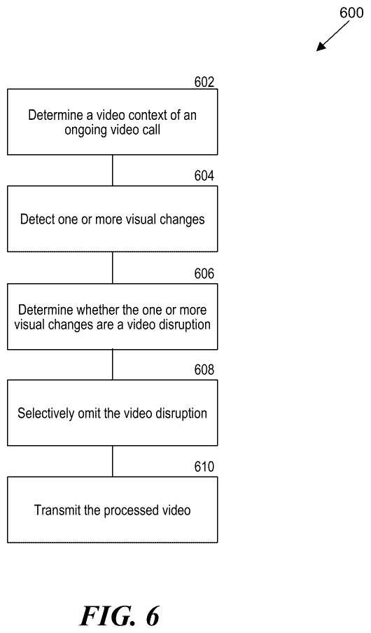

FIG. 6 is a flow diagram 600 illustrating a process for mitigating video disruptions in a video data stream corresponding to a video call. Such calls can include audio data and are able to mitigate audiovisual disruptions in the corresponding audiovisual data stream. These steps can be performed on any computer system, including a personal computer or a mobile device. A video call is between at least a first device, which sends associated video data, and a second device, that receives associated video data. The call may include other devices that also send and receive video data. Any such device can be any computing device, such as a personal computer, mobile device, or cloud-based network server.

At 602, the system determines a video context of an ongoing video call. The video context of a call can include various aspects of the visual environment and communication characteristics. In some implementations, the video context can encompass the visual surroundings of the caller, such as the type of location (e.g., office, public space, or home), which can help distinguish between expected visual elements and potential disruptions. For example, the appearance of another person can be considered a video disruption in a private office context, but not when the caller is in a public space. The video context can also include the number of participants expected in the call, their relative positions, and the general level of movement in the background. In some cases, the video context can take into account the type of call, such as a professional meeting or a casual conversation, which can influence what is considered a disruption. In some implementations, the video context of the call can be determined in part by analyzing the video data stream using an AI model.

At 604, the system detects one or more visual changes in the video data stream associated with the ongoing video call.

At 606, while the call is ongoing, the system determines whether the one or more visual changes are a video disruption based on the video context. A video disruption is a visual change (also called a video event) that falls outside a video context of a call corresponding to the video data stream. In some implementations, the system determines a video context by receiving an indication of the video context from another device. In some implementations, the detection can be performed in real time while a call is ongoing. The system can analyze the video data stream using various techniques, which can include employing an artificial intelligence (AI) model trained to identify video events that fall outside a video context of the call. Such models can be trained on video data along with training labels that indicate the times during which a video disruption occurs. For example, video data wherein a user paused their video during a video disruption can be labeled with the times during which the user manually paused the video. Furthermore, such models can be trained on data labeled with the location of the video data in which the video disruption occurs. This can correlate with certain environmental elements. For example, a door that is visible in the video scene represents a region of the video data with a higher risk of a video disruption since another person can enter the scene through the door. Such training data can be used to identify high-risk elements of the video data. Any particular region corresponding to a region depicting such a high-risk element can be marked as a candidate region of the video data stream, indicating that it is a high-risk region more likely to produce a video disruption.

At 608, the video data stream is processed to selectively omit the video disruption based on a video mitigation preference setting. The processing can be in response to the occurrence of the disruption detected at 606. The system first determines a video mitigation preference setting indicating whether a video disruption in the ongoing call is to be removed or otherwise selectively omitted. This can involve accessing a stored user preference or presenting options to a user through a user interface to establish how video disruptions should be handled. The preference setting can indicate whether a video disruption in a video data stream is to be removed or otherwise selectively omitted. The preference setting can be set by a user prior to the occurrence of the call. In some implementations, the detection of a video disruption during a call causes a notification to be displayed to a user that includes video mitigation options. The user can then change the preference setting in response to the detection of the video disruption, such as indicating that the video disruption is to be removed from the video data stream.

In some implementations, the selective omission can involve blocking the video data stream for the duration of the disruption. In other cases, the system can apply video processing techniques to remove or reduce the impact of the video disruption while preserving other visual content. For instance, the system can blur, darken, or pixelate a specific region of the video where the video disruption is detected. This specific region can correspond to the region of the video disruption (e.g., the high-risk region associated with a high-risk element of the video data stream) or can incorporate a large region of the video data (e.g., blurring everything except one or more users depicted in the video data stream). This video mitigation action can be performed along with a notification action in accordance with a video mitigation preference setting. A notification action can include notifying the user of the video mitigation action, such as presenting to a user a notification that the video disruption has been omitted from the video data stream or notifying the user that a video disruption has been detected but that no video mitigation action has been taken, for instance, when a video mitigation preference setting is such that no video mitigation action is to be taken. The notification can further include the presentation of options for changing a video mitigation preference setting.

In some implementations, there can be an audio data stream associated with the call corresponding to the video data stream, together making an audiovisual data stream. This audio data stream can be processed independently to detect and mitigate audio disruptions or can be processed in conjunction with the video data stream for determining video disruptions. In some implementations, an audio data stream associated with the video data stream is processed, and an occurrence of an audio event associated with a video event is determined. These events can together be indicative of a video disruption (i.e., the video event is determined to be a video disruption), an audio disruption (i.e., the audio event is determined to be an audio disruption), or an audiovisual disruption (i.e., a disruption in both the audio data and the video data). Thus, some implementations can detect an occurrence of a video disruption in the video data stream while the call is ongoing, based at least in part on the occurrence of the audio event. Furthermore, the audio event can also be selectively omitted from the audio data stream by processing the audio data stream.

At 610, the processed video stream is transmitted. The transmission can occur in real time, allowing for seamless continuation of the call with reduced impact from the detected disruption.

The processes described above for FIGS. 5 and 6 can be modified to mitigate audiovisual disruptions in an audiovisual data stream corresponding to a video conference. An audiovisual data stream includes both an audio data stream and a video data stream. In some implementations, a system analyzes an audiovisual data stream to determine an associated audiovisual context, which represents an expected audio surrounding and visual surrounding of one or more users of the ongoing video conference. The system detects one or more audiovisual events, which can include audio noises (i.e., audio events) and/or visual changes (i.e., video events), associated with the ongoing video conference. While the video conference is ongoing, the system determines whether the one or more audiovisual events represent an occurrence of an audiovisual disruption based on the audiovisual context. The system performs an audiovisual mitigation action, such as processing the audiovisual stream to selectively omit the audiovisual disruption, based on an audiovisual mitigation preference setting. This can include processing the audio data, processing the video data, or both. The audiovisual mitigation preference setting can include options to omit a disruption from the audio data stream and/or the video data stream. For example, a person entering the video scene can be a video disturbance and the voice of the person can be an audio disturbance, which, together, can be an audiovisual disturbance. The audiovisual disturbance can be omitted based on a preference setting by omitting the video disturbance, omitting the audio disturbance, or omitting both. Furthermore, the system can selectively omit the audio disturbance when the system detects that the video disturbance will already be omitted, such as when the background of a video scene is being blurred in its entirety by another setting. The system can similarly omit the video disturbance when the system detects that the audio disturbance will be omitted by another setting, such as when the audio is muted. The system can omit a disruption from the audio data stream and/or the video data stream in accordance with the techniques described above pertaining to omitting audio disruptions and video disruptions. In some implementations, the system presents a notification to a user notifying the user of the audiovisual mitigation action, which can further include the presentation of options for changing an audiovisual mitigation preference setting.

In some implementations, the audiovisual context of the video conference can be determined in part by analyzing the audiovisual data stream using an AI model. In some implementations, the system detects an audiovisual disturbance by processing the audiovisual data stream using an AI model. This can include processing the audio data stream and the video data stream separately by one or more AI models each. For example, the system can use AI models to detect an audio disruption and/or a video disruption using the techniques described above with respect to FIGS. 5 and 6. In some implementations, the system processes the audio data stream and the video data stream together by one or more AI models. Such AI models can be trained on audiovisual data along with training labels that indicate the times during which an audiovisual disruption occurs.

### Artificial Intelligence (AI) Models

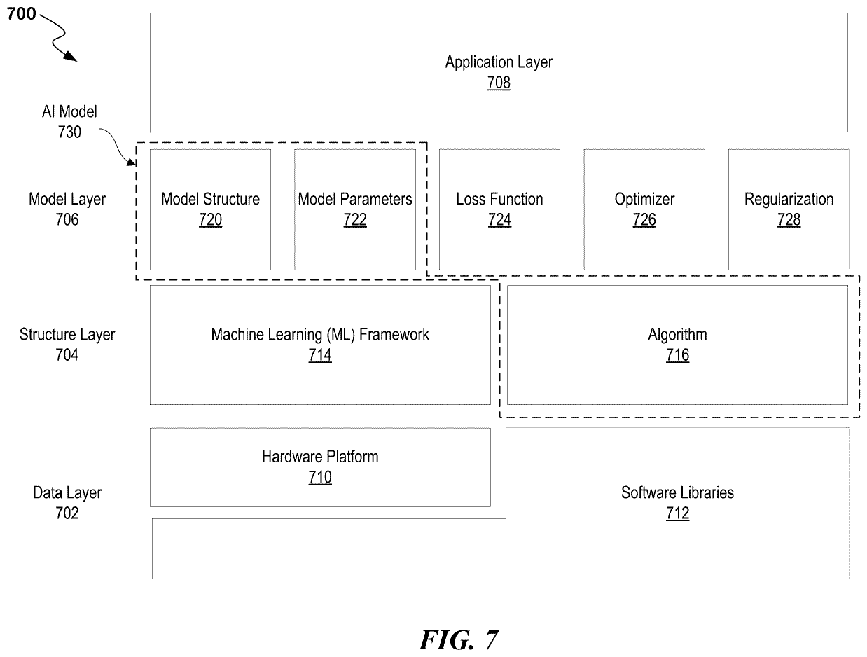

FIG. 7 is a block diagram illustrating an implementation of an artificial intelligence (AI) system 700 which can implement some aspects of the disclosed technology.

The AI system 700 can include a set of layers, which conceptually organize elements within an example network topology for the AI system's architecture to implement a particular AI model. Generally, an AI model is a computer-executable program implemented by the AI system 700 that analyzes data to make predictions. In some implementations, the AI model can include various other models, including machine learning (ML) models, such as neural networks trained to identify entities in pre-processed input data, classify entities in pre-processed input data, identify recurrence and other patterns in pre-processed input data, generate indexes, generate smart variables, generate indicators, and so forth.

In the AI model, information can pass through each layer of the AI system 700 to generate outputs for the AI model. The layers can include an environment layer 702, a structure layer 704, a model optimization layer 706, and an application layer 708. The algorithm 716, the model structure 720, and the model parameters 722 of the structure layer 704 together form an example AI model 730. The loss function engine 724, optimizer 726, and regularization engine 728 of the model optimization layer 706 work to refine and optimize the AI model, and the environment layer 702 provides resources and support for application of the AI model by the application layer 708.

The environment layer 702 acts as the foundation of the AI system 700 by preparing data for the AI model. As shown, the environment layer 702 can include sub-layer components, such as a hardware platform 710 and one or more software libraries 712. The hardware platform 710 can be designed to perform operations for the AI model and can include computing resources for storage, memory, logic and networking. The hardware platform 710 can process amounts of data using one or more servers. The servers can perform backend operations such as matrix calculations, parallel calculations, machine learning (ML) training, and the like. Examples of servers used by the hardware platform 710 include central processing units (CPUs), graphics processing units (GPUs), neural processing units (NPUs), and system-on-chips (SoC). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. NPUs are specialized circuits that implement the necessary control and arithmetic logic to execute machine learning algorithms. NPUs can also be referred to as tensor processing units (TPUs), neural network processors (NNPs), intelligence processing units (IPUs), and vision processing units (VPUs). SoCs are IC chips that comprise most or all components found in a functional computer, including an on-chip CPU, volatile and permanent memory interfaces, I/O operations, and a dedicated GPU, within a single microchip. In some instances, the hardware platform 710 can include Infrastructure as a Service (IaaS) resources, which are computing resources (e.g., servers, memory, etc.) offered by a cloud services provider. The hardware platform 710 can also include computer memory for storing data about the AI model, application of the AI model, and training data for the AI model. The computer memory can be a form of random-access memory (RAM), such as dynamic RAM, static RAM, and non-volatile RAM.

The software libraries 712 can be thought of as suites of data, programming code, including executables, used to control and optimize the computing resources of the hardware platform 710. The programming code can include low-level primitives (e.g., fundamental language elements) that form the foundation of one or more low-level programming languages, such that servers of the hardware platform 710 can use the low-level primitives to carry out specific operations. The low-level programming languages do not require much, if any, abstraction from a computing resource's instruction set architecture, allowing them to run quickly with a small memory footprint. Examples of software libraries 712 that can be included in the AI system 700 include software libraries Intel Math Kernel Library, Nvidia cuDNN, Eigen, and Open BLAS. The software libraries 712 may also feature distribution software, or package managers, that manage dependency software. Distribution software enables version control of individual dependencies and simplified organization of multiple collections of programming code. Examples of distribution software include PyPI and Anaconda.

The structure layer 704 can include an ML framework 714 and an algorithm 716. The ML framework 714 can be thought of as an interface, library, or tool that allows users to build and deploy the AI model. The ML framework 714 can include an open-source library, an application programming interface (API), a gradient-boosting library, an ensemble method, and/or a deep learning toolkit that work with the layers of the AI system to facilitate development of the AI model. For example, the ML framework 714 can distribute processes for application or training of the AI model across multiple resources in the hardware platform 710. The ML framework 714 can also include a set of pre-built components that have the functionality to implement and train the AI model and allow users to use pre-built functions and classes to construct and train the AI model. Thus, the ML framework 714 can be used to facilitate data engineering, development, hyperparameter tuning, testing, and training for the AI model. Examples of ML frameworks 714 that can be used in the AI system 700 include TENSORFLOW, PYTORCH, SCIKIT-LEARN, SCIKIT-FUZZY, KERAS, CAFFFE, LIGHTGBM, RANDOM FOREST, FUZZY LOGIC TOOLBOX, and AMAZON WEB SERVICES (AWS).

The ML framework 714 serves as an interface for users to access pre-built AI model components, functions, and tools to build and deploy custom designed AI systems via programming code. For example, user-written programs can execute instructions to incorporate available pre-built structures of common neural network node layers available in the ML framework 714 into the design and deployment of a custom AI model. In other implementations, the ML framework 714 is hosted on cloud computing platforms offering modular machine learning services that users can modify, execute, and combine with other web services. Examples of cloud machine learning interfaces include AWS SageMaker and Google Compute Engine. In other implementations, the ML framework 714 also serves as a library of pre-built model algorithms 716, structures 720, and trained parameters 722 with predefined input and output variables that allow users to combine and build on top of existing AI models. Examples of ML frameworks 714 with pretrained models include Ultralytics and MMLab.

The algorithm 716 can be an organized set of computer-executable operations used to generate output data from a set of input data and can be described using pseudocode. The algorithm 716 can include program code that allows the computing resources to learn from new input data and create new/modified outputs based on what was learned. In some implementations, the algorithm 716 can build the AI model through being trained while running computing resources of the hardware platform 710. This training allows the algorithm 716 to make predictions or decisions without being explicitly programmed to do so. Once trained, the algorithm 716 can run at the computing resources as part of the AI model to make predictions or decisions, improve computing resource performance, or perform tasks. The algorithm 716 can be trained using supervised learning, unsupervised learning, semi-supervised learning, self-supervised learning, and/or reinforcement learning.

Using supervised learning, the algorithm 716 can be trained to learn patterns (e.g., match input data to output data) based on labeled training data, such as transaction categorization data, entity behavior map data, and so forth.

Supervised learning can involve classification and/or regression. Classification techniques involve teaching the algorithm 716 to identify a category of new observations based on training data and are used when the input data for the algorithm 716 is discrete. Said differently, when learning through classification techniques, the algorithm 716 receives training data labeled with categories (e.g., classes) and determines how features observed in the training data relate to the categories. Once trained, the algorithm 716 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 716 is continuous. Regression techniques can be used to train the algorithm 716 to predict or forecast relationships between variables. To train the algorithm 716 using regression techniques, a user can select a regression method for estimating the parameters of the model. The user collects and labels training data that is input to the algorithm 716 such that the algorithm 716 is trained to understand the relationship between data features and the dependent variable(s). Once trained, the algorithm 716 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 716 learns patterns from unlabeled training data. In particular, the algorithm 716 is trained to learn hidden patterns and insights of input data, which can be used for data exploration or for generating new data. Here, the algorithm 716 does not have a predefined output, unlike the labels output when the algorithm 716 is trained using supervised learning. Said another way, unsupervised learning is used to train the algorithm 716 to find an underlying structure of a set of data, group the data according to similarities, and represent that set of data in a compressed format.

The model optimization layer 706 implements the AI model using data from the environment layer 702 and the algorithm 716 and ML framework 714 from the structure layer 704, thus enabling decision-making capabilities of the AI system 700. The model optimization layer 706 can include a model structure 720, model parameters 722, a loss function engine 724, an optimizer 726, and/or a regularization engine 728.

The model structure 720 describes the architecture of the AI model of the AI system 700. The model structure 720 defines the complexity of the pattern/relationship that the AI model expresses. Examples of structures that can be used as the model structure 720 include decision trees, support vector machines, regression analyses, Bayesian networks, Gaussian processes, genetic algorithms, and artificial neural networks (or, simply, neural networks). The model structure 720 can include a number of structure layers, a number of nodes (or neurons) at each structure layer, and activation functions of each node. Each node's activation function defines how a node converts data received to data output. The structure layers may include an input layer of nodes that receive input data and/or an output layer of nodes that produce output data. The model structure 720 may include one or more hidden layers of nodes between the input and output layers. The model structure 720 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 722 represent the relationships learned during training and can be used to make predictions and decisions based on input data. The model parameters 722 can weight and bias the nodes and connections of the model structure 720. For instance, when the model structure 720 is a neural network, the model parameters 722 can weight and bias the nodes in each layer of the neural networks, such that the weights determine the strength of the nodes and the biases determine the thresholds for the activation functions of each node. The model parameters 722, in conjunction with the activation functions of the nodes, determine how input data is transformed into desired outputs. The model parameters 722 can be determined and/or altered during training of the algorithm 716.

The model structure 720, parameters 722, and algorithm 716 formally comprise the design, properties, and implementation of an AI model 730. The structure 720 defines the types of input data used, types of output data produced, and parameters 722 available that can be modified by the algorithm 716. The model parameters 722 are assigned values by the algorithm 716 that determine the characteristics and properties of a specific model state. For example, the algorithm 716 can improve model task performance by adjusting the values of parameters 722 that reduces prediction errors. The algorithm 716 is responsible for processing input data to be compatible with the model structure 720, executing the AI model 730 on available training data, evaluating performance of model output, and adjusting the parameters 722 to reduce model errors. Thus, the model structure 720, parameters 722, and algorithm 716 comprise co-dependent functionalities and are the core components of an AI model 730.

The loss function engine 724 can determine a loss function, which is a metric used to evaluate the AI model's performance during training. For instance, the loss function engine 724 can measure the difference between a predicted output of the AI model and the actual output of the AI model and is used to guide optimization of the AI model during training to minimize the loss function.

The optimizer 726 adjusts the model parameters 722 to minimize the loss function during training of the algorithm 716. In other words, the optimizer 726 uses the loss function generated by the loss function engine 724 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 726 used may be determined based on the type of model structure 720 and the size of data and the computing resources available in the environment layer 702.

The regularization engine 728 executes regularization operations. Regularization is a technique that prevents over-and under-fitting of the AI model. Overfitting occurs when the algorithm 716 is overly complex and too adapted to the training data, which can result in poor performance of the AI model. Underfitting occurs when the algorithm 716 is unable to recognize even basic patterns from the training data such that it cannot perform well on training data or on validation data. The optimizer 726 can apply one or more regularization techniques to fit the algorithm 716 to the training data properly, which helps constrain the resulting AI model and improves its ability for generalized application. Examples of regularization techniques include lasso (L1) regularization, ridge (L2) regularization, and elastic (L1 and L2 regularization).

The application layer 708 describes how the AI system 700 is used to solve problem or perform tasks. This layer can include various application-specific modules that utilize the outputs generated by the AI model 730 to execute specific functions. For instance, the application layer 708 can implement modules for natural language processing, image recognition, predictive analytics, audiovisual processing, and autonomous decision-making. These modules can be tailored to address particular use cases, such as customer service automation, medical diagnosis, financial forecasting, and industrial automation. The application layer 708 thus serves as the interface between the AI system 700 and end-users, enabling practical deployment of AI capabilities in real-world scenarios.

### Computer System

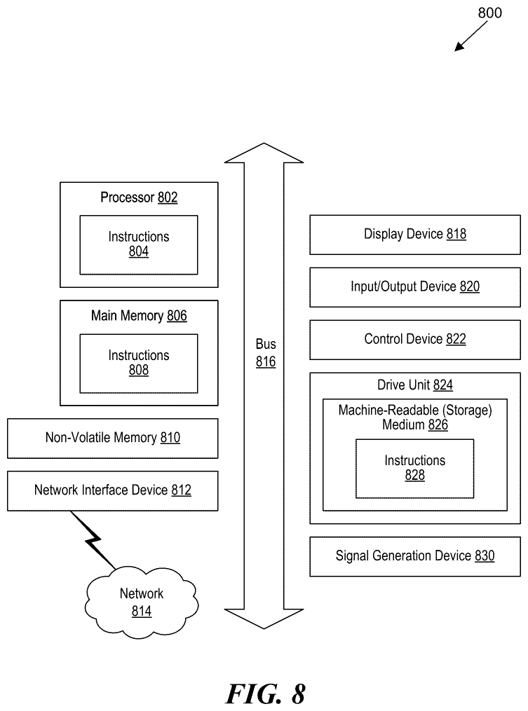

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A device for making an audio call to a second device, comprising:
at least one hardware processor; and
at least one non-transitory memory storing instructions, which, when executed by the at least one hardware processor, cause the device to:
determine an audio context of an ongoing audio call by analyzing an audio data stream associated with the ongoing audio call,
wherein the audio context represents an expected audio surrounding of a user in the ongoing audio call;
detect one or more audio noises in the audio data stream;
determine, based on the audio context, whether the one or more audio noises represent an occurrence of an audio disruption in the audio data stream,
wherein the audio disruption comprises an audio event that falls outside the audio context of the ongoing audio call;
in response to the occurrence of the audio disruption, process the audio data stream by selectively omitting the audio disruption in the audio data stream based on a preference setting indicating whether an audio disruption in the ongoing audio call is to be removed; and
transmit the processed audio data stream to the second device.

2. The device of claim 1, wherein the audio context is determined based on an ambient audio volume, one or more ambient audio noises, or a speaking voice of a user.

3. The device of claim 1, wherein the device uses an artificial intelligence (AI) model configured to analyze the audio data stream and to determine the audio context.

4. The device of claim 3, where the AI model is trained using audio data comprising training labels indicating times during which one or more audio disruptions occur.

5. The device of claim 3, where the AI model is trained using audio data comprising training labels indicating times during which a user manually muted the audio data stream corresponding to the audio call.

6. The device of claim 1, wherein the instructions stored on the memory further cause the at least one hardware processor to:
present to a user a notification that the audio disruption has been omitted from the audio data stream.

7. The device of claim 1, wherein the preference setting is determined based on:
displaying, to a user and in response to the detection of the occurrence of the audio disruption, an option to change the preference setting; and
receiving a selection indicating that the audio disruption is to be removed.

8. A device for making a video call, comprising:
at least one hardware processor; and
at least one non-transitory memory storing instructions, which, when executed by the at least one hardware processor, cause the device to:
determine a video context of an ongoing video call by analyzing a video data stream associated with the ongoing video call,
wherein the video context represents an expected visual surrounding of a user in the ongoing video call,
detect one or more visual changes in the video data stream;
detect, based on the video context, whether the one or more visual changes represent an occurrence of a video disruption in the video data stream,
wherein the video disruption comprises a video event that falls outside the video context of the ongoing video call;
in response to the occurrence of the video disruption, process the video data stream by selectively omitting the video disruption in the video data stream based on a preference setting indicating whether a video disruption in the ongoing video call is to be removed; and
transmit the processed video data stream.

9. The device of claim 8, wherein the video context is determined based on a number of participants in a video scene, a location of a video scene, or an average amount of motion in a video scene.

10. The device of claim 8, wherein the device uses an artificial intelligence (AI) model configured to analyze the video data stream and to determine the video context.

11. The device of claim 10, where the AI model is trained using video data comprising training labels indicating times during which a video disruption occurs or times during which the user manually paused the ongoing video call.

12. The device of claim 8, wherein the instructions stored on the memory further cause the at least one hardware processor to:
identify a particular region in a video scene as a candidate region for a video disruption, and
in response to the occurrence of the video disruption, process the video data stream by selectively omitting the particular region in the video data stream based on the preference setting.

13. The device of claim 8, wherein selectively omitting the video disruption involves blurring the video disruption in the video data stream.

14. A computer-implemented method, comprising:
determining a video conference context of an ongoing video conference by analyzing an associated audiovisual data stream,
wherein the audiovisual data stream comprises an audio data stream and a video data stream,
wherein the video conference context represents an expected audio surrounding of a user and an expected visual surrounding of the user in the ongoing video conference;
detecting one or more audiovisual events in the audiovisual data stream;
detecting, based on the video conference context, whether the one or more audiovisual events represent an occurrence of an audiovisual disruption;
processing, in response to the occurrence of the audiovisual disruption, the audiovisual data stream to selectively omit the audiovisual disruption based on a preference setting indicating whether an audiovisual disruption in the ongoing video conference is to be removed; and
transmitting the processed audiovisual data stream.

15. The method of claim 14, wherein processing the audiovisual data stream is performed on a cloud-based network server.

16. The method of claim 14, further comprising:
detecting an audio noise in the audio data stream and a simultaneous visual change in the video data stream,
wherein the audio noise and visual change together comprise an audiovisual event;
detecting, based on the video conference context, whether the audiovisual event represents an occurrence of an audiovisual disruption; and
processing the audiovisual data stream to selectively omit the audiovisual disruption by omitting the audio noise from the audio data stream.

17. The method of claim 14, further comprising:
processing the audio data stream and the video data stream using one or more artificial intelligence (AI) models configured to determine the video conference context.

18. The method of claim 17, where at least one of the one or more AI models is trained using audiovisual data comprising training labels indicating times during which a user manually muted an audio data stream or paused a video data stream corresponding to the video conference.

19. The method of claim 17, where at least one of the one or more AI models is trained using audiovisual data comprising training labels indicating times during which one or more audiovisual disruptions occur.

20. The method of claim 14, further comprising:
presenting to a user a notification that the audiovisual disruption has been omitted from the audiovisual data stream.
